(19) United States
(12) Patent Application Publication
(10) Pub. No.: US 2026/0194643 A1
(43) Pub. Date: Jul. 9, 2026

(54) METHOD FOR OPERATING AN OBJECT CAPTURING SYSTEM OF A VEHICLE, AS WELL AS OBJECT CAPTURING SYSTEM AND MOTOR VEHICLE

(71) Applicant: Valeo Schalter und Sensoren GmbH, Bietigheim-Bissingen (DE)

(72) Inventors: Kevin Krupinski, Bietigheim-Bissingen (DE); Yoke Leen Sit, Bietigheim-Bissingen (DE); Anamika Yadav, Bietigheim-Bissingen (DE)

(73) Assignee: Valeo Schalter und Sensoren GmbH, Bietigheim-Bissingen (DE)

(21) Appl. No.: 19/132,122

(22) PCT Filed: Nov. 20, 2023
(86) PCT No.: PCT/EP2023/082431

§ 371 Date: May 22, 2025

(30) Foreign Application Priority Data
Nov. 24, 2022 (DE) 10 2022 131 082.5

(51) Int. Cl. G01S 13/04; B60R 21/015; E05F 15/40; E05F 15/73; G01S 13/88

(52) U.S. Cl. CPC G01S 13/04; B60R 21/01534; E05F 15/40; E05F 15/73; G01S 13/88; E05F 2015/765

(57) ABSTRACT

Described is a method for operating an object capturing system of a vehicle. The method includes recognizing whether a door of the vehicle is in a closed or an open position. When the door is arranged in the closed position, a passenger recognition mode is performed. A radar sensor arranged on the door is oriented with its capturing range towards a seat in the passenger compartment of the vehicle adjacent to the door, and the radar sensor captures whether the seat is occupied by a passenger. When the door is arranged in the open position, a movement space capturing mode is performed. A radar sensor arranged on the door is oriented with its capturing range towards a movement space of the door between an inner surface of the door and a body of the vehicle, and the radar sensor captures whether an object is present in the movement space.

One aspect of the invention relates to a method for operating an object capturing system of a vehicle. A further aspect of the invention relates to an electronic object capturing system. A further aspect of the invention relates to a motor vehicle.

From the prior art it is known that a radar sensor can be arranged on a body of a vehicle external to the door. By the radar sensor persons in the interior as well as outside in the environment of the vehicle can be captured with the door closed. In this regard, reference may be made to document US 2022/0111856 A1.

It is a task of the present invention to provide a method, in which a multifunctional object capturing by means of radar sensors in a vehicle is achieved.

This task is solved by a method, an electronic object capturing system, and a motor vehicle according to the independent claims.

An aspect of the invention relates to a method for operating an object capturing system of a vehicle, comprising the following steps:
recognizing whether a door of the vehicle is arranged in a closed position or in an open position;
in case the door is arranged in the closed position, performing a passenger recognition mode of the object capturing system, in which at least one radar sensor of the vehicle arranged on the door is oriented with its capturing range towards that seat in the passenger compartment of the vehicle which is adjacent to the door, and capturing by the radar sensor whether the seat is occupied by a passenger;
in case the door is arranged in the open position, performing a movement space capturing mode of the object capturing system, in which the at least one radar sensor of the vehicle arranged on the door with its capturing range is oriented towards a movement space of the door between the inner surface of the door and the body of the vehicle, and capturing by the radar sensor whether in the movement space an object is present.

With the method it is therefore now facilitated to perform by at least one and the same radar sensor different capturing modes, in which different ranges and/or objects can be captured. By the specific position of the at least one radar sensor on the door of the vehicle itself already a situation is created that the radar sensor can be installed in a compact and space-saving way, whilst, on the other hand, being motion-coupled with the movable door. Thereby, already a very advantageous situation is created, in which it is generally only facilitated, in the first place, to perform the very concrete modes, namely on the one hand the passenger recognition mode and on the other hand the movement space capturing mode with regard to their ranges to be locally specifically captured. This is because thereby it is already facilitated that the radar sensor itself upon movement of the door and the concrete positions of the door named in the above-named method also orients its capturing ranges accordingly automatically in the intended directions or these are adjusted accordingly. In this connection it is particularly advantageous that in the movement space capturing mode that movement space can be monitored by the radar sensor, which is formed between the inner surface of the door and the entry area of the body of the vehicle which can be closed by the door. Thus, it is facilitated particularly advantageously that in this mode objects, which are located in this movement space or enter it, can be recognized at an early stage. Then a door hitting an object in this movement space when being closed can then be avoided. Equally, it is thus also achieved that such objects in this movement space when closing the door do not hit this door and thus the door is not damaged, either. By the position of the radar sensor on the door it is also particularly advantageous that in different open positions of the door also different large movement spaces are formed. These, too, can then be comprehensively captured by the radar sensor which is quasi moving along with the door, since the capturing range is invariably automatically adjusted in such a way that these movement spaces are captured comprehensively.

The at least one radar sensor is therefore used in two different operating modes in such a way that it is differently oriented depending on the position of the door with its capturing range and thereby monitors very concrete areas on the one hand in the passenger compartment, on the other hand between the inner side of the opened door and this entry area to the body, which by this door can be closed. Thereby, also in very advantageous manner a jam detection and jam prevention system is created, which works on the basis of the radar sensor.

In an embodiment the radar sensor is a microwave radar sensor. It therefore works on the basis of microwave radiation. In particular the radar sensor may be an imaging microwave radar sensor.

By this technology of the radar sensor highly precise object recognitions can be realized. Not only is the detection accuracy increased thereby, but also the kinds of objects and/or their movement state, whether static or dynamic, can thereby be recognized in an improved manner.

Especially by such radar sensors then the very concrete above-named areas to be checked, on the one hand the passenger compartment adjacent to the door when the door is closed, on the other hand the very concretely defined movement space of the door when the door is open, can be detected.

In an embodiment the radar sensor is configured to comprise only a single antenna. The radar sensor may be switched between a receiving operation and a transmitting operation. For both operation modes then the same antenna is used. By such setup the radar sensor can be realized in a particularly compact manner. Especially when installed on the door thus generally only a reasonable realization and space-saving design can be achieved. Particularly for the near field detection such a radar sensor is particularly advantageous. In particular the radar sensor thus comprises a capturing range, which amounts to less than 2 m, in particular between 20 cm and 200 cm.

In an embodiment the position of the door is captured by at least one sensor of the object capturing system. This sensor is different from the radar sensor. Thus, the position of the door, in particular the closed position of the door and the open position of the door, can be exactly captured.

In an embodiment in the movement space capturing mode the automatic closing of the door is at least slowed down, in particular stopped, when in the movement space an object is captured. Thus, in an advantageous embodiment it is also possible that the door of the vehicle at least in portions can be automatically closed. Especially in the case of the door being very wide open this is advantageous. In this connection namely a passenger need not reach far for the outwardly swiveled door to be able to pull it close and close it. This is particularly advantageous for more senior or motion-impaired persons. So if the vehicle has an electronic closing system, by which the door of the vehicle starting from the open state at least in portions can be automatically moved towards the closing position or the closed position, the above-named embodiment is particularly advantageous. This is because then a jamming of the object in the movement space between the door and the body and/or a damaging of the door when colliding with the object, which is present in the movement space, can be avoided.

In an embodiment in the movement space capturing mode the automatic opening of the door, can at least be slowed down, in particular stopped, if an approaching target was captured by at least one of the radar sensors. If the sensors are directed to the movement space the sensors will also see beyond that movement space, such that approaching objects, like cars or bicycles, can be detected. This can prevent accidents when opening the doors.

In an embodiment a visual evidence signal and/or an acoustic evidence signal is generated by the object capturing system when in the movement space capturing mode an object is captured in the movement space or an approaching object is detected. In particular this at least one evidence signal is also output by an output unit of the object capturing system. Such evidence signal may be useful for a passenger in the vehicle to be able to manually respond, if need be.

In an embodiment in the passenger recognition mode it is checked whether the vehicle is standing still and/or is locked. A vehicle that is standing still is in particular given when a drive unit is switched off. A vehicle that is standing still may, however, also be given when the drive unit is activated, the vehicle, however, is at a standstill. A locked vehicle is given in particular when access to the interior of the vehicle is closed. Because of the fact that such constellations of a vehicle that is standing still and/or locked occur in particular when the vehicle is standing still, a passenger recognition mode is advantageous especially in such situations. This is because then in particular it may also be recognized when a passenger, for instance also a child, is still in the car. By such an embodiment it is then also facilitated that it is recognized if a passenger is inadvertently locked into a vehicle that is standing still and/or locked. For instance then locked-children, but also animals can be recognized. Then a corresponding evidence signal can be generated and output. This, too, may for instance be an acoustic and/or a visual evidence signal.

In an embodiment it is facilitated that in such a case, in which the vehicle is standing still and/or locked, an observation mode of the object capturing system is activated. In particular in an embodiment, when a passenger in the vehicle is recognized, this observation mode can be activated. Then, on the basis of this observation mode the vehicle passenger can be further observed. In such an embodiment then a corresponding evidence signal need not be generated straight away. Thus, it can also be avoided that immediately undesired evidence signals are generated. This is because there may also be situations, in which a passenger very deliberately is in the vehicle that is standing still and/or locked vehicle in the passenger compartment. For instance when a passenger takes a rest period at a parking lot. Even if a passenger in the car is sleeping because he is for instance spending the night there, this is then possible without an undesired evidence signal being generated.

Preferably the passenger in the observation mode is captured by at least one interior camera of the vehicle. Such capturing may be effected in discrete points in time or else continuously. Thus, in such situations, which commonly do not envisage any passengers in the vehicle, in particular when the vehicle is standing still and/or locked, still a passenger will be present in the vehicle, in particular be admitted, however he will be observed. This is advantageous to be able to assess conditions, in particular health conditions, if any, of the passenger in such situations. In particular cameras are particularly suitable for this due to their imaging capturing. A very comprehensive and precise analysis of the passenger, in particular with regard to his condition, is thereby facilitated.

In particular at least depending on information of the at least one interior camera a condition, in particular a health condition, of the passenger can be assessed by an assessment unit of the object capturing system. For example in this connection the facial expression and/or the complexion and/or the posture and/or other biometric information of the passenger may be captured and evaluated. To this end, also for instance further cameras, such as for instance an infrared camera, may be envisaged. It is then also possible that a temperature sensor and/or a humidity sensor in the passenger space of the vehicle are present. Thereby corresponding parameters can be captured and evaluated. In particular thereby due to parameters characterizing the condition of the passenger himself and/or due to parameters characterizing the passenger compartment and/or in particular parameters characterizing the environment of the vehicle, an improved assessment result with regard to the condition of the passenger can be generated. Especially when for instance relatively high temperatures and/or high air humidity are given, for instance a health condition of a passenger in the passenger interior may grow more critical or faster more critical than is the case at normal temperatures and/or normal air humidity. The same may also be the case at very cold temperatures so that also then, if any, critical or undesired health conditions also occur and can be captured faster.

In an embodiment in the observation mode the passenger is captured by the at least one radar sensor. Depending on this captured information a vital function of the passenger is determined. Thus, it is also possible to detect for instance the breathing or the heartbeat, which are examples of vital functions, by the radar sensor.

In an embodiment a radar sensor is arranged behind an inner lining of the door. This radar sensor with its capturing range is oriented towards the inner lining. This means it is oriented facing away from an outside cladding of the door. Precisely such a position, on the one hand, allows for a compact and hidden installation of the radar sensor in the door itself. On the other hand, especially by this orientation the particular advantage is created that the above-named different modes, namely the passenger capturing mode and the movement space capturing mode, can be performed in a very exact way. This means that also by the position of this radar sensor in fixed location on the door behind the inner lining, even when the door is closed, orienting the capturing range of the radar sensor very precisely to that seat which is arranged adjacent to this door is achieved. On the other hand, by this position also in the case of a variety of opening angles of the door, which is pivotably arranged, the capturing range of the radar sensor is invariably such that it covers the resulting movement space, be it larger or smaller, which is depending on the opening width or the pivot angle of the door, respectively.

In an embodiment a first radar sensor is arranged behind the inner lining of the door and with its capturing range is oriented towards the inner lining of the door. A separate second radar sensor of the object capturing system is arranged in an embodiment behind the inner lining of the door and with its capturing range oriented towards the inner lining of the door. The two radar sensors are arranged separate and spaced apart from each other on the door. By such a concept comprising two radar sensors the two modes are once again improved to the effect that the detection precision is raised. This is because in this way in this connection it is also possible that passengers of different sizes who are sitting on a seat can be detected more easily by the two radar sensors. In this way a radar sensor with its detection range for instance may detect rather the seating area of the seat, whereas the other radar sensor is rather oriented at the area of the back rest. Moreover, by such an equipment with radar sensors also in the movement space capturing mode it is still facilitated in a targeted way to detect objects at different positions in the movement space. Also several such objects in the movement space at different points in the height direction and in the depth direction of the vehicle thus can be detected more easily and more precisely.

In an embodiment the capturing ranges are oriented at different height positions and/or at different depth positions, each viewed in the height direction of the vehicle and in the longitudinal direction of the vehicle. By such an offset of the radar sensors the above-named advantages may be achieved to a particular degree.

A further aspect of the invention relates to an electronic object capturing system for a vehicle. The object capturing system comprises at least one door of a vehicle. Moreover the electronic object capturing system comprises at least one radar sensor, which is arranged on the door of the vehicle, in particular fixed in location. The radar sensor is arranged with its capturing range facing away towards an external surface of the door. Moreover the electronic object capturing system comprises an evaluation unit. The object capturing system is configured for performing a method according to the above-named aspect or an advantageous embodiment thereof. In particular this method is performed by the object capturing system.

In an embodiment the object capturing system comprises at least one sensor for capturing the position of the door. Thus, both the closed position as well as the open position can be captured very precisely. In particular in an embodiment it is also possible that in the open position also the pivot position can captured by sensors. Thus, different opening widths of the door may be recognized. In particular this also involves a different size of the named movement space. Thereby again different constellations for objects arise, which may be present in such differently sized movement spaces. By the above-named embodiments then also with the at least one radar sensor in such different constellations with differently sized movement spaces a precise detection of objects can be achieved.

In an embodiment the electronic object capturing system comprises at least two separate radar sensors. These may be locally arranged on the door in such a way as it has already been explained above.

A further aspect of the invention relates to a motor vehicle with an electronic object capturing system according to the above-named aspect or an advantageous embodiment thereof.

Embodiments of the invention are explained in the following in more detail by reference to schematic drawings. These show in:

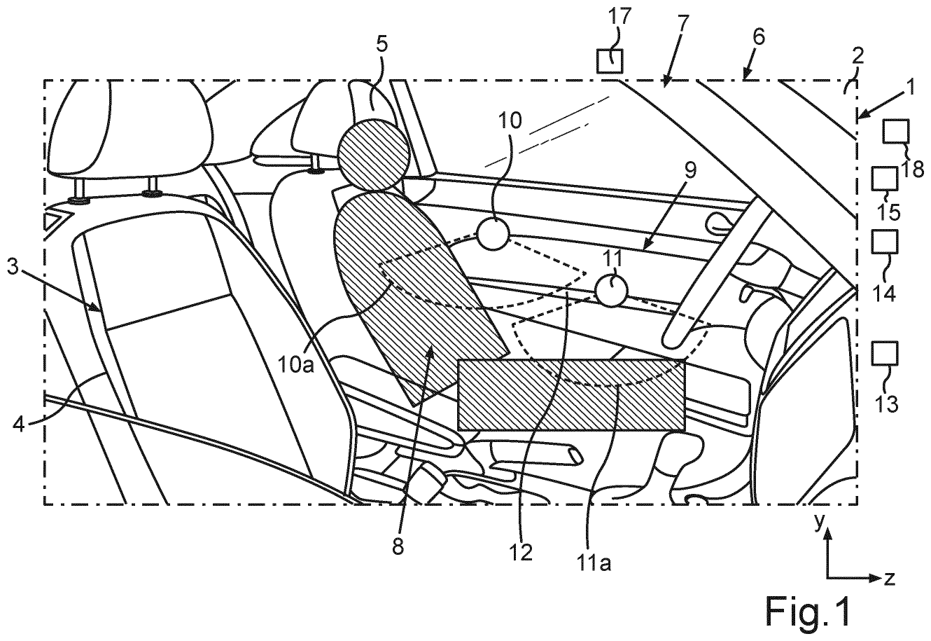

FIG. 1 a perspective view of a subportion of a motor vehicle according to the invention with an embodiment of an electronic object capturing system according to the invention, wherein in FIG. 1 a subportion of the passenger compartment of the motor vehicle is shown; and

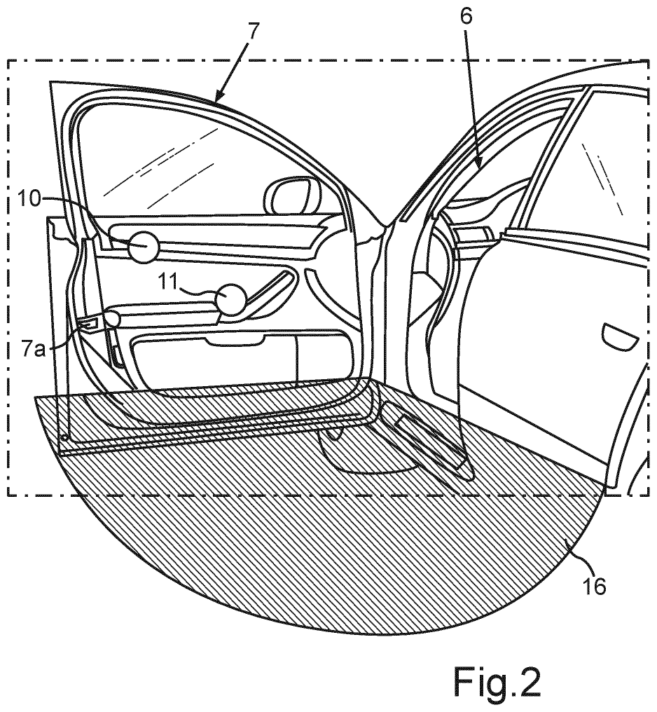

FIG. 2 a perspective view of a subportion of the motor vehicle according to FIG. 1, in which a door of the motor vehicle in the open position is arranged and a movement space between the inner surface of the door and the body of the vehicle is formed.

In the figures identical and functionally identical elements are equipped with the same reference signs.

In FIG. 1 in a perspective view a motor vehicle 1 is shown. The motor vehicle 1 is in particular a passenger car. The motor vehicle 1 comprises a body 2. Moreover, the motor vehicle 1 also comprises a passenger compartment 3. Exemplarily in the passenger compartment 3 in FIG. 1 a vehicle seat 4 and a further vehicle seat 5 are shown. In an example the vehicle seat 4 may be for a co-driver. The vehicle seat 5 may be for a driver of the vehicle. In particular when the motor vehicle 1 is not a fully autonomously operated motor vehicle, these designations for the vehicle seats 4 and 5 are given. If the motor vehicle 1 is a fully autonomously operated vehicle and if in this connection no vehicle operator and thus no driver is present anymore, these vehicle seats 4, 5 are generally to be referred to as front seats.

The body 2 comprises an entry area 6. This entry area 6 is an opening of the body 2, through which a person or a vehicle user can enter the passenger compartment 3 and can sit on the vehicle seat 5 adjacent thereto. This entry area 6 can be closed by a door 7 of the motor vehicle 1. The door 7 is movably arranged on the body 2. In particular it may be correspondingly pivoted. In FIG. 1 the door 7 is shown in the closed state. Merely symbolically in FIG. 1 a passenger 8 is shown, who has taken a seat on the vehicle seat 5.

In an embodiment, the motor vehicle 1 comprises an electronic object capturing system 9. In an embodiment, this electronic object capturing system 9 comprises at least one radar sensor. In the shown embodiment, the electronic object capturing system 9 comprises a first radar sensor 10 and a second radar sensor 11 which is separate thereto. These two radar sensors 10 and 11 are arranged in fixed location in the door 7. In particular they are arranged behind an inner lining 12 of the door 7. They are here arranged offset in the height direction (y direction) and in the depth direction, which corresponds to the vehicle longitudinal direction (z direction). The schematically drawn capturing ranges 10a and 11a of the radar sensors 10, 11 are facing away from an external surface of the door 7. In particular the capturing ranges 10a and 11a are facing the passenger compartment 3 when the door 7 is closed. In particular they are oriented such that a passenger 8 on the vehicle seat 5 is detected. In particular by the radar sensor 10 the passenger 8 can be captured at least in the region of his torso. By the radar sensor 11 the passenger 8 can be captured at least at his thighs.

In particular thus the main directions of orientation of the capturing ranges 10a and 11a are pointing into the passenger compartment 3 when the door 7 according to the representation in FIG. 1 is closed.

Especially these radar sensors 10 and/or 11 are arranged under a window of the door 7, viewed in height direction.

Preferably the object capturing system 9 also comprises an evaluation unit 13. The evaluation unit 13 may be a control unit. The evaluation unit 13 can be part of the radar sensors 10 and/or 11.

Moreover, the electronic object capturing system 9 may also comprise a sensor 14. By this sensor 14 the position of the door 7 can be captured. In particular in this connection the closed position, as it is shown in FIG. 1, can be captured. Also the open position of the door 7 shown in FIG. 2 may be shown.

In an embodiment, it is also possible that the door 7 at least in portions is moved automatically from the open position shown in FIG. 2 towards the closed position shown in FIG. 2. For this purpose the motor vehicle 1 may comprise a door movement device 15.

It is particularly advantageous that the object detection system 9 is operable in a passenger recognition mode and in a movement space capturing mode that is different therefrom.

This is also depending on the position of the door 7.

In the method for operating the electronic object capturing system 9 in particular the following steps are performed:
recognizing whether a door 7 of the vehicle 1 is arranged in a closed position or in an open position;
in case the door 7 is arranged in the closed position, performing a passenger recognition mode of the object capturing system 9, in which at least one radar sensor 10, 11 of the vehicle 1 arranged on the door 7 is oriented with its capturing range 10a, 11a towards that seat 4, 5 in the passenger compartment 3 of the vehicle 1 which is adjacent to the door 7, and capturing by the radar sensor 10, 11 whether the seat 4, 5 is occupied by a passenger 8;
in case the door 7 is arranged in the open position, performing a movement space capturing mode of the object capturing system 9, in which the at least one radar sensor 10, 11 of the vehicle 1 arranged on the door 7 with its capturing range 10a, 11a is oriented towards a movement space 16 of the door 7 between the inner surface 7a of the door 7 and the body 2 of the vehicle 1, and capturing by the radar sensor 10, 11 whether in the movement space 16 an object is present.

In the method thus for instance also in the representation in FIG. 2 it can be recognized that the door 7 is arranged in the open position. Therein then a movement space 16 between the door 7, in particular an inner surface 7a of the door 7, and the entry area 6 results.

In an embodiment in the movement space capturing mode the automatic closing of the door 7, for instance starting from the representation in FIG. 2, can at least be slowed down, in particular stopped, if in this movement space 16 an object was captured by at least one of the radar sensors 10 and/or 11.

In an embodiment in the movement space capturing mode the automatic opening of the door 7, can at least be slowed down, in particular stopped, if an approaching object was captured by at least one of the radar sensors 10 and/or 11.

It may be envisaged that, if an object was captured in the movement space 16 or an approaching object was captured, in the movement space capturing mode a visual and/or acoustic evidence signal is generated and output.

In the passenger recognition mode set in FIG. 1, in which the door 7 is arranged in the closed position, in an embodiment it is also checked whether the vehicle, in particular the motor vehicle 1 is standing still and/or is locked. If this is the case and if a passenger 8 is recognized for instance on the vehicle seat 5, in an embodiment an observation mode of the object capturing system 9 may be activated.

It may be envisaged in an embodiment that the passenger 8 in this observation mode is captured for instance by at least one interior camera 17 of the motor vehicle 1. It may be envisaged that at least depending on the information of the interior camera 17 a condition, in particular a health condition, of the passenger 8 is assessed. For this purpose in particular an assessment unit 18 of the object capturing system 9 may be provided. It is also possible that in this observation mode the passenger 8 is captured by the at least one radar sensor 10 and/or 11 and depending on the captured information of the at least one radar sensor 10 and/or 11 vital functions of the passenger 8 are assessed.

In particular here the two exemplarily provided radar sensors 10 and 11 are microwave radar sensors. They may be in particular imaging microwave radar sensors.

1. A method for operating an object capturing system of a vehicle, comprising
recognizing whether a door of the vehicle is arranged in a closed position or in an open position;
in case the door is arranged in the closed position, performing a passenger recognition mode of the object capturing system, in which at least one radar sensor of the vehicle arranged on the door is oriented with its capturing range towards a seat in a passenger compartment of the vehicle which is adjacent to the door, and capturing by the at least one radar sensor whether the seat is occupied by a passenger; and
in case the door is arranged in the open position, performing a movement space capturing mode of the object capturing system, in which the at least one radar sensor of the vehicle arranged on the door is oriented with its capturing range towards a movement space of the door between the inner surface of the door and a body of the vehicle, and capturing by the at least one radar sensor whether an object is present in the movement space.

2. The method according to claim 1, wherein the position of the door is captured by at least one sensor of the object capturing system.

3. The method according to claim 1, wherein in the movement space capturing mode an automatic closing of the door is slowed when the object is captured in the movement space.

4. The method according to claim 1, wherein in the movement space capturing mode an automatic opening of the door is slowed when an approaching object is captured by the at least one radar sensor.

5. The method according to claim 1, wherein when in the movement space capturing mode the object is captured or an approaching object is captured, a visual and/or acoustic evidence signal is generated and output by the object capturing system.

6. The method according to claim 1, wherein in the passenger recognition mode, checking whether the vehicle is standing still and/or is locked, and when the vehicle is standing still and/or locked, and a passenger on the seat is captured, activating an observation mode of the object capturing system.

7. The method according to claim 6, wherein in the observation mode the passenger is captured by the at least one radar sensor, and depending on the captured information, vital functions of the passenger are determined.

8. The method according to claim 1, wherein the at least one radar sensor is arranged behind an inner lining of the door with its capturing range oriented towards the inner lining.

9. The method according to claim 8, wherein a first radar sensor is arranged behind the inner lining of the door with its capturing range oriented towards the inner lining, and a second radar sensor is arranged behind the inner lining of the door with its capturing range oriented towards the inner lining.

10. The method according to claim 9, wherein the capturing ranges of the first and second radar sensors are arranged at different height positions and/or at different depth positions.

11. An electronic object capturing system for a vehicle, comprising:
at least one door of the vehicle;
at least one radar sensor arranged on the door of the vehicle with its capturing range facing away to an external surface of the door; and
an evaluation unit,
wherein the object capturing system is configured for performing the method according to claim 1.

12. The electronic object capturing system according to claim 11, comprising at least one sensor for capturing a position of the door.

13. The electronic object capturing system according to claim 11, wherein a first radar sensor is arranged behind an inner lining of the door and is arranged with its capturing range oriented towards the inner lining, and a second radar sensor is arranged behind the inner lining of the door and is arranged with its capturing range oriented towards the inner lining, wherein the capturing ranges of the radar sensors are arranged at different height positions and/or at different depth positions.

14. A motor vehicle comprising the electronic object capturing system according to claim 11.
